(19) United States
(12) Patent Application Publication
(10) Pub. No.: US 2014/0238546 A1
(43) Pub. Date: Aug. 28, 2014

(54) SYSTEMS AND METHODS OF ORIENTING A CANT IN LUMBER MILLS

(71) Applicant: WEYERHAEUSER NR COMPANY, FEDERAL WAY, WA (US)

(72) Inventor: Earl Barker, Enumclaw, WA (US)

(73) Assignee: WEYERHAEUSER NR COMPANY, Federal Way, WA (US)

(21) Appl. No.: 14/178,596

(22) Filed: Feb. 12, 2014

Related U.S. Application Data
(60) Provisional application No. 61/768,193, filed on Feb. 22, 2013.

(51) Int. Cl. B27B 31/06; B23Q 17/20

(52) U.S. Cl. CPC B27B 31/06; B23Q 17/20
USPC 144/357; 83/367

(57) ABSTRACT

Processing of a cant may include determining a rotational orientation about a longitudinal axis of the cant that optimizes a recovery from the cant from subsequent sawing operations. Such may include optimizing a width of a board that will be produced dependent on the particular rotational longitudinal orientation. Such may include determining a surface area of a board which would be produced, a thickness of a board that would be produced, and/or a volume of a board that would be produced. Such may include accounting for any premium associated with various width categories in which a board that would be produced would fit. Such may account for any premium associated with grade or quality of a board that would be produced. A corresponding signal may provide information to a human operator and/or automated machinery to orient the cant in an optimized orientation.

### CROSS-REFERENCE TO RELATED APPLICATION

This application is entitled to and claims the benefit of priority under 35 U.S.C. §119 from U.S. Provisional Patent Application Ser. No. 61/768,193 filed Feb. 22, 2013, and titled “Systems and Methods of Operation of Equipment in Lumber Mills,” the contents of which are incorporated herein by reference.

### TECHNICAL FIELD

This description generally relates to sawmills or lumber mills, and more particularly to an orientation of a cant in such mills such as hardwood lumber mills.

### DESCRIPTION OF THE RELATED ART

The lumber mill industry has become largely automated. Full length tree trunks are delivered to lumber mills, where they are automatically debarked and bucked (i.e., cut into log segments). These log segments are then typically processed at a number of automated stations, depending on the lumber mill and the type of wood (e.g., softwood species, hardwood species). These processing stations produce lumber from each log segment. Whether processing softwood or hardwood species, one or more band saws are typically employed for removing sideboards from the log segments, leaving a middle portion of the log which is called a cant. When processing softwood species, the cant typically has a pair of flat faces which are substantially parallel to one another, the faces produced by removal of the sideboards. When processing hardwood species, the cant typically has two pairs of flat faces, the faces of each pair being substantially parallel to one another, the faces produced by removal of the sideboards.

In many lumber mills, one or more processing stations may have an associated optimizer system which makes determinations regarding the optimal way to saw each piece to maximize the value and volume of lumber produced from the raw logs. These optimizer systems are very complicated and expensive, and are also difficult to manage properly because of their complexity. If some portion of an optimizer system is not performing as expected, the lumber mill can easily suffer a 1% to 4% loss of value until the problem is found and fixed. Thus, significant sums of money may be lost should any one optimizer system not function correctly.

Processing of hardwood species focuses on producing boards of the highest grade possible. Thus, the processing typically includes assessing outer surfaces or “sides” of a cant to determine a rotational orientation of the cant about a longitudinal axis thereof which will result in a sawing or cutting operation that produces a board of the highest grade possible given the exposed surfaces of the cant. A depth of cut is also determined, thicker boards being of higher value. However, the depth must be balanced with the possibility or reducing the grade of the resulting board. A single board is sawn or cut at a time. The modified (i.e., sawn or cut) cant is then reassessed and a decision made with respect to a next cut. This process is typically repeated until a size of the remaining cant or quality of boards that can be produced dictates using the remainder for pallet material or for rail ties.

These orientation and sawing or cutting decisions are typically made by a human operator. The human operator controls a device that flips cants. The operator may flip the cants to expose sides that would otherwise be hidden from view, and/or to orient the cant for sawing or cutting by a linebar resaw. Human operators typically rely on judgment, developed over many years, visually assessing the grade of the exposed surfaces, and assessing the likelihood of defects beneath the exposed surfaces, reducing the grade of a possible board. Typically, the operator will choose to saw or cut faces of a given orientation or 180° from the given orientation through multiple passes, until out of clear wood on the particular face.

A width of the resulting board is variable, the goal generally to produce the widest board possible without reducing the grade. Boards are generally sawn or cut to a number of nominal thicknesses. For instance, many lumber mills may produce boards denominated as anywhere from 1/4 thick to 8/4 thick, where 4/4 corresponds to an approximately 1 inch thick board and 8/4 corresponds to an approximately 2 inch thick board.

This contrasts with the typically commercial processing of softwood species, where volume or speed typically dominates over grade. In softwood mills, cants are typically sawn using a gang saw (e.g., single arbor, double arbor). Thus, a cant is typically concurrently or simultaneously sawn or cut into multiple pieces or boards. In some instances, mills may employ curve sawing to attempt to maximize the value of the resulting lumber. Yet, the processing of the cant involves the concurrent or simultaneous complete sawing or cutting of the cant. Sawing or cutting of softwood species is generally performed to realize pieces of defined nominal dimensions (e.g., 2 inch by 4 inch, 2 inch by 6 inch, 2 inch by 8 inch, 4 inch by 4 inch). Thus, when processing softwood species, at least the nominal thickness and nominal width of the resulting boards are typically not variable.

Modern lumber mills operate under relatively small profit margins, and even small increases in efficiency can produce significant savings and/or revenue. Likewise, small increases in efficiency may significantly reduce the amount of raw resources (e.g., trees), required to produce a given amount of lumber of particular grades and/or dimensions. New approaches are thus desirable.

A lumber mill can hypothetically manually review their processes by looking at the computed solutions as presented via the user interface, and manually comparing the actual lumber produced to the lumber that has been predicted by the optimization system. Computationally simulating by at least one processor a plurality of sawing solutions may include simulating respective sawing solutions at each of a number of increments spaced perpendicularly in two directions from a sawn face of at least one of the boards in the simulated cant.

### BRIEF SUMMARY

Processing of a cant may include determining a rotational orientation about a longitudinal axis of the cant that optimizes a recovery from the cant from subsequent sawing operations. Such may include optimizing a width of a board that will be produced dependent on the particular rotational longitudinal orientation. Such may include determining a surface area of a board which would be produced, a thickness of a board that would be produced, and/or a volume of a board that would be produced. Such may include accounting for any premium associated with various width categories in which a board that would be produced would fit. Such may account for any premium associated with grade or quality of a board that would be produced. A corresponding signal may provide information to a human operator and/or automated machinery to orient the cant in an optimized orientation.

A method of orienting a cant in lumber mills may be summarized as including acquiring via a subsystem at least dimensional data from a cant in a first condition; determining from the acquired dimensional data an at least approximate lateral dimension of at least one exposed face of a first pair of exposed faces of the cant by at least one processor, the at least one exposed faces of the first pair opposed to one another across the cant; determining from the acquired dimensional data an at least approximate lateral dimension of at least one exposed face of a second pair of exposed faces of the cant by the at least one processor, the at least one exposed faces of the second pair opposed to one another across the cant and not parallel to the exposed faces of the first pair; determining based on the determined at least approximate lateral dimensions an orientation of the cant that would result in a board sawn from the cant having a width that is as close to without being less than a defined fractional value of a defined unit of length measurement by the at least one processor; and providing an optimized orientation signal by the at least one processor, the optimized orientation signal indicative of an optimized orientation of the cant based at least in part on the determined orientation of the cant that would result in a board sawn from the cant having the width that is as close to without being less than the defined fractional value of a defined unit of length measurement.

The method of orienting a cant in lumber mills may further include determining by the at least one processor a width category for each of a number of boards that would be sawn from the cant at a number of respective orientations, and assessing any width category premium associated with the determined width categories, and wherein providing an optimized orientation signal by the at least one processor may include providing the optimized orientation signal based at least in part on the assessment of the width category premium associated with the determined width categories.

The method of orienting a cant in lumber mills may further include determining from the acquired dimensional data an at least approximate longitudinal dimension associated with at least one exposed face of the cant by the at least one processor; and wherein providing an optimized orientation signal by the at least one processor may include providing the optimized orientation signal based at least in part on the determined at least approximate longitudinal dimension associated with the at least one exposed face of the cant.

The method of orienting a cant in lumber mills may further include determining a value of a board that would be sawn from the cant based at least in part on a volume of a board that would be sawn from the cant, the volume equal to a product of at least one of the determined lateral dimensions multiplied by the determined at least approximate longitudinal dimension of the cant and a thickness equal to a defined sawing depth.

Acquiring via a subsystem at least dimensional data from a cant in a first condition may include acquiring grade data which represents aberrations, if any, in a portion of the cant, and may further include determining from the acquired grade data an at least approximate grade for at least one of the exposed faces of the cant by the at least one processor; and wherein providing an optimized orientation signal by the at least one processor may include providing the optimized orientation signal based at least in part on the determined at least approximate grade for the at least one of the exposed faces of the cant.

The method of orienting a cant in lumber mills may further include determining a value of a board that would be sawn from the cant based at least in part on the determined at least approximate grade for the at least one of the exposed faces of the cant.

The method of orienting a cant in lumber mills may further include recommending the optimized orientation of the cant to a human operator; and receiving a command from the human operator, the command indicative of a desired orientation of the cant.

The method of orienting a cant in lumber mills may further include determining by the at least one processor whether the cant is in the optimized orientation indicated by the optimized orientation signal; sending orientation signals by the at least one processor that cause the cant to be automatically rotated into the optimized orientation; and sending drive signals by the at least one processor that cause the cant to advance toward a linebar resaw.

The method of orienting a cant in lumber mills may further include acquiring via a subsystem at least dimensional data from the cant in a second condition, the second condition resulting from a sawing of the cant in the first condition; determining from the acquired dimensional data an at least approximate lateral dimension of at least one exposed face of a first pair of exposed faces of the cant in the second condition by at least one processor, the at least one exposed faces of the first pair opposed to one another across the cant; determining from the acquired dimensional data an at least approximate lateral dimension of at least one exposed face of a second pair of exposed faces of the cant in the second condition by the at least one processor, the at least one exposed faces of the second pair opposed to one another across the cant and not parallel to the exposed faces of the first pair; determining based on the determined at least approximate lateral dimensions an orientation of the cant that would result in a board sawn from the cant in the second condition having a width that is as close to without being less than a defined fractional value of a defined unit of length measurement by the at least one processor; providing an optimized orientation signal by the at least one processor, the optimized orientation signal indicative of an optimized orientation of the cant in the second condition based at least in part on the determined orientation of the cant that would result in a board sawn from the cant having the width that is as close to without being less than the defined fractional value of a defined unit of length measurement.

Determining based on the determined at least approximate lateral dimensions an orientation of the cant that will result in sawing a board having a width that is as close to without being less than a defined fractional value of a defined unit of length may include determining based on the determined at least approximate lateral dimensions the orientation of the cant that will result in sawing a board having a width that is as close to without being less than half of a foot.

The method of orienting a cant in lumber mills may further include determining from the acquired dimensional data an at least approximate longitudinal dimension associated with at least one exposed face of the cant by the at least one processor; wherein determining from the acquired dimensional data the at least approximate longitudinal dimension associated with the at least one exposed face of the cant by the at least one processor may include accessing a lookup table stored in at least one non-transitory processor-readable medium communicatively coupled to the at least one processor or executing a mathematical formula stored in the at least one non-transitory processor-readable medium communicatively coupled to the at least one processor.

A system of orienting a cant may be summarized as including a data acquisition subsystem having at least one data collection component positioned to acquire at least dimensional data from a cant in a first condition; at least one non-transitory processor-readable medium that stores at least one of instructions and data; at least one processor communicatively coupled to the data acquisition subsystem and the at least one non-transitory processor-readable medium and that, in operation: determines from the acquired dimensional data an at least approximate lateral dimension of at least one exposed face of a first pair of exposed faces of the cant, the at least one exposed faces of the first pair opposed to one another across the cant; determines from the acquired dimensional data an at least approximate lateral dimension of at least one exposed face of a second pair of exposed faces of the cant, the at least one exposed faces of the second pair opposed to one another across the cant and not parallel to the exposed faces of the first pair; determines based on the determined at least approximate lateral dimensions an orientation of the cant that would result in a board sawn from the cant having a width that is as close to without being less than a defined fractional value of a defined unit of length measurement; and provides an optimized orientation signal indicative of an optimized orientation of the cant based at least in part on the determined orientation of the cant that would result in a board sawn from the cant having the width that is as close to without being less than the defined fractional value of a defined unit of length measurement.

The at least one processor may further determine a width category for each of a number of boards that would be sawn from the cant at a number of respective orientations, and assess any width category premium associated with the determined width categories, and provide the optimized orientation signal based at least in part on the assessment of the width category premium associated with the determined width categories.

The at least one processor may further determine from the acquired dimensional data an at least approximate longitudinal dimension associated with at least one exposed face of the cant by the at least one processor; and provide the optimized orientation signal based at least in part on the determined at least approximate longitudinal dimension associated with the at least one exposed face of the cant.

The at least one processor may further determine a value of a board that would be sawn from the cant based at least in part on a volume of a board that would be sawn from the cant, the volume equal to a product of at least one of the determined lateral dimensions multiplied by the determined at least approximate longitudinal dimension of the cant and a thickness equal to a defined sawing depth.

The data acquisition subsystem may further acquire grade data which represents aberrations, if any, in a portion of the cant, and the at least one processor may further determine from the acquired grade data an at least approximate grade for at least one of the exposed faces of the cant by the at least one processor; and provide the optimized orientation signal based at least in part on the determined at least approximate grade for the at least one of the exposed faces of the cant.

The at least one processor may further recommend the optimized orientation of the cant to a human operator; and receive a command from the human operator, the command indicative of a desired orientation of the cant.

The at least one processor may further determine whether the cant is in the optimized orientation indicated by the optimized orientation signal; and send orientation signals to a portion of a flipper table that cause the cant to be automatically rotated into the optimized orientation.

The data acquisition subsystem may include at least one laser scanner acquisition devices and at least one image acquisition device. The at least one non-transitory processor-readable medium may store at least one of a lookup table or a mathematical formula that relates at least surface area, thickness, and/or grade to value.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an example lumber mill having at least one optimizer system, according to one illustrated embodiment.

FIG. 2A is an isometric view of an exemplary cant, according to one illustrated embodiment.

FIG. 2B is a right side elevational view of the exemplary cant of FIG. 2A.

FIG. 2C is a left side elevational view of the exemplary cant of FIG. 2A.

FIG. 2D is a top plan view of the exemplary cant of FIG. 2A.

FIG. 2E is a bottom plan view of the exemplary cant of FIG. 2A.

FIG. 3 is a front end elevational view of the exemplary cant of FIGS. 2A-2E showing theoretical saw lines and resulting dimensions, in support of explaining one illustrated embodiment.

FIG. 4 is a schematic diagram of an optimizer system for use in controlling at least some of the equipments of FIG. 1, according to one illustrated embodiment.

FIGS. 5A-5D are flow diagrams of methods of providing optimized orientation signals for orienting a cant, according to illustrated embodiments.

FIG. 6 is a flow diagram of a method of operation of an optimizer system, according to one illustrated embodiment, which may be used in conjunction with the methods of FIGS. 5A-5D.

FIG. 7 is a flow diagram of a method of operation of an optimizer system, according to one illustrated embodiment, which may be used in conjunction with the methods of FIGS. 5A-5D.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with lumber mills, head rigs, linebar resaws, edgers, trimmers, saws, conveyors, computing devices, imaging systems and/or laser scanners have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

As used herein, lumber is a broad term, referring to any piece of wood, including, for example, uncut, undebarked logs, partially processed logs, log segments, cants, sideboards, flitches, edging strips, boards, finished lumber, etc. The term, log, unless apparent from its context, is also used in a broad sense and may refer to, inter alia, uncut, undebarked logs, partially processed logs or log segments.

The headings and Abstract of the Disclosure provided herein are for convenience only and do not interpret the scope or meaning of the embodiments.

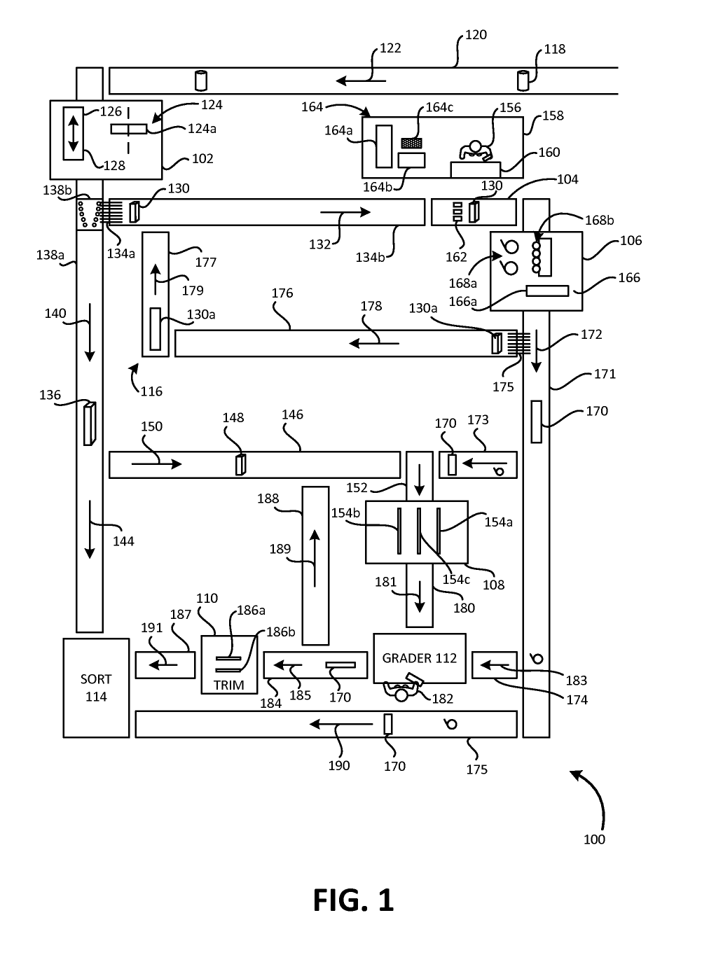

FIG. 1 shows a lumber mill environment 100, according to one illustrated embodiment. In particular, the lumber mill environment 100 is illustrated for use in a hardwood lumber mill for processing hardwood species of trees. Many of the structures, machines, processes and techniques described herein are particularly suited to hardwood lumber mills, and may not be suitable to commercial softwood lumber mills in which softwood species of trees are processed.

The flow is generally indicated by arrows. It is recognized that other lumber mills may include additional machines, may omit one or more of the illustrated machines, and/or may process logs into sawn lumber in a different manner.

Processing of hardwood species typically employs assessing a sawing or cutting of a cant to produce a board of the highest grade possible. A single board is cut at a time, and the remaining cant reassessed and decision again made with respect to a sawing or cutting operation to produce the next board.

Thus, hardwood processing typically focuses on a few pieces of machinery and/or stations, namely one or more head rigs (one shown) 102, a flipper table 104, one or more a linebar resaws 106 (one shown), one or more edgers 108, one or more trimmers 110 and a grading station 112. The lumber mill environment 100 may include other pieces of machinery and stations, for instance, a sorting deck 114. The various pieces of equipment or stations are coupled by conveyors (e.g., transfer tables, roll cases, chains, belt conveyors), for instance, to form a “merry-go round” 116 as described in detail below.

The lumber mill environment 100 may, for example, include one or more bucking saws (not shown) operated to buck logs into sections of desired lengths. The lumber mill environment 100 may include one or more log sort decks (not shown) where bucked logs are sorted, for example, by species, size and intended end use.

Logs 118 enter the lumber mill environment 100 via a log deck 120. The logs 118 are typically in the form of log segments, which may or may not have been previously debarked. The logs are generally circular in cross section and the segments may have any variety of lengths, for instance from 8 feet to 16 feet. Logs 118 used in hardwood processing typically come in one foot increments, from 8 feet to 16 feet, although such should not be considered limiting or in any way necessary to the various embodiments described herein.

The logs 118 are transported as indicated by arrow 122 to a first processing station, typically denominated as the head rig 102. The head rig 102 typically includes a saw 124 with a saw blade 124a and a carriage 126 that moves with respect to the saw blade 124a as indicated by double headed arrow 128. The saw 124 may take the form of a band saw oriented with a principal portion of the saw blade 124a sawing or cutting in a vertical plane. The carriage 126 carries a log 118, and moves the log 118 longitudinally with respect to the saw blade 124a. The saw blade 124a may have teeth on both edges and the carriage 126 may be controlled to saw or cut in two directions, that is as the log 118 advances downstream, and then as the log 118 is returned upstream, as indicated by double headed arrow 128. The head rig 102 typically saws or cuts only the outermost portions of the log 118 to create a cant 130, having four sides, opposed pairs of sides being at least roughly parallel to one another. The cant 130 is advanced downstream toward the linebar resaw 106 as indicated by arrow 132, via one or more conveyors, such as chains 134a and a first transfer table 134b, which is described in detail below.

In creating the cant 130, a first cut on the log 118 by the head rig 102 produces a slab which has one flat side and the rest is a rounded shape. The slab (not shown) may be directly sent to a chipper (not shown) when it is too thin. Otherwise, the slab may be sent to the linebar resaw 106 to produce a second flat side. After the first cut, the head rig 102 may cut a flitch 136 which has two flat sides, and sometimes other boards. The flitch 136 or other boards may be sent to the linebar resaw 106 for further processing. One or more conveyors such as belt conveyer 138a and/or roll case 138b may convey or transport the flitch 136 or other boards downstream, as indicated by arrow 140, to the edger 108, or directly to a sorting deck 114. In particular, a conveyor 138 advances the flitch 136 or other boards to a diverter 142 where some pieces of lumber which do not require edging are conveyed or transported directly to the sorting deck 114 as indicated by arrow 144, while a conveyor 146 conveys or transports pieces of lumber 148 which require edging to the edger 108 as indicated by arrow 150. Typically, when the pieces of lumber 148 carry or have some amount of wane (visible in FIG. 1), they may require edging to remove the wane. As illustrated another conveyer 152 conveys or transports the pieces of lumber 148 through the edger 108.

The edger 108 preferably includes three saws 154a, 154b, and 154c (collectively 154), for instance, round saws. Two of the saws 154a and 154b may be oriented to saw or cut through a thickness of the piece of lumber 148 slightly in from two edges thereof. This sawing or cutting may remove wane, producing a relatively higher grade piece of lumber than one with wane. The third saw 154c may be configured to split a wide piece of lumber into two narrow ones. The two pieces might be of two different grades. Often an edger optimizer will be employed to control the edger 108 to make edging, sawing or cutting in order to produce pieces of lumber of optimum value.

At the flipper table 104, a decision is made as to which longitudinal rotational orientation of the cant will result in the highest grade piece of lumber being produced by the linebar resaw 106. In conventional mills, this would typically involve a human operator 156 in a cab 158 or other location, visually inspecting one or more outer surfaces of the cant. The human operator 156 operates a set of controls 160 to, for example, control a flipper 162 (e.g., arms with concave portion that are selectively extendable and retractable below an upper portion of the flipper table 104), which rotates the cant 130 about a longitudinal axis (i.e., rotational longitudinal axis) of the cant 130. Typically, the human operator 156 attempts to identify the longitudinal rotational orientation which will result in sawing or cutting the highest grade board possible from the cant 130. The cant 130 is delivered to the linebar resaw 106 in the longitudinal rotational orientation identified or set by the human operator 156.

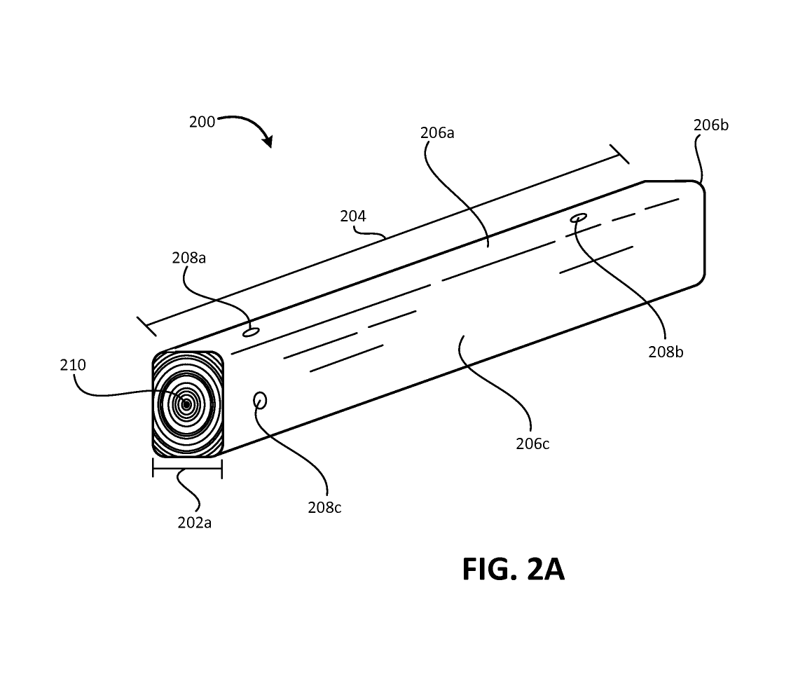

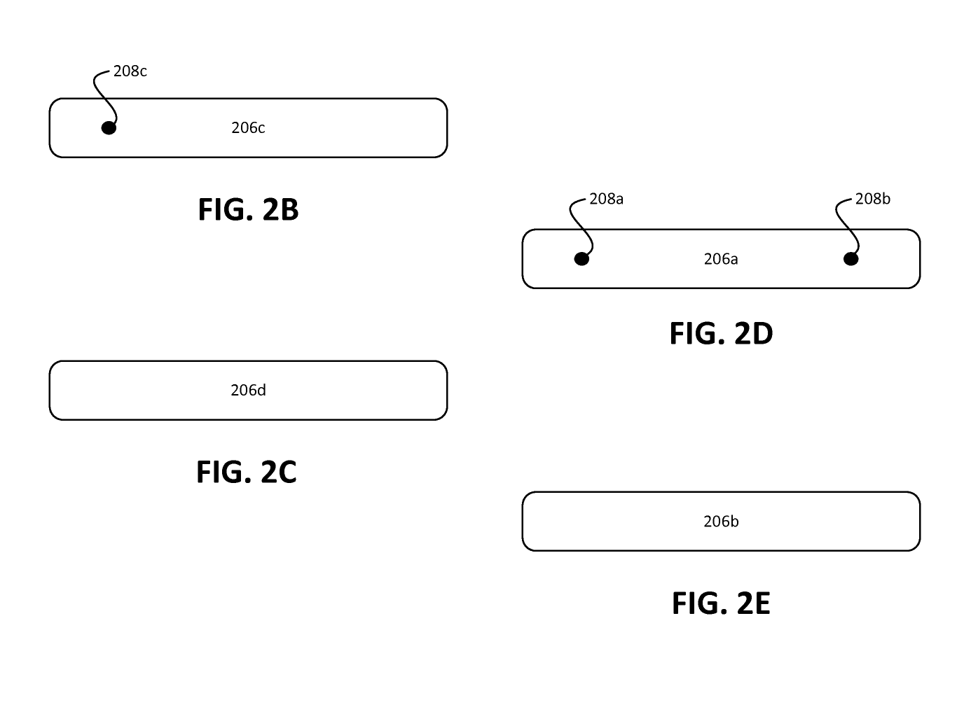

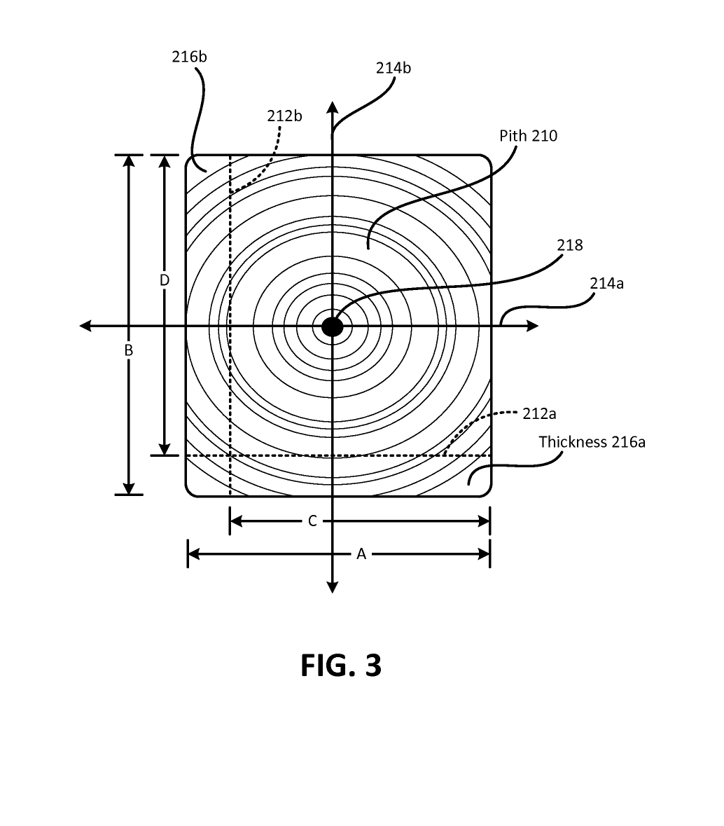

In at least some approaches described herein, a human operator 156 is prompted (e.g., visually, aurally, tactilely) with processor generated information to assist in making the decision as to which longitudinal rotational orientation of the cant 130 will result in pieces of lumber being produced which optimizes the value resulting from processing of the cant 130 by the linebar resawing. In contrast to simply determining which longitudinal rotational orientation will produce the highest grade board, the processing takes into account additional factors which result in the cant 130 being processed to result in an optimized value. Such advantageously takes into account factors such as breakpoints in board width and length, as described in detail below with reference to FIGS. 2A-2E and 3. Such may optionally additionally take into account the grade of the boards which would result from any particular longitudinal rotational orientation, but such is not necessary to the operation. In some implementations, a control subsystem 164 may aid, or completely replace, the human operator 156. As illustrated, the control subsystem may include a computer (e.g., processor, nontransitory processor-readable storage media) 164a and user input/out devices such as a display 164b and keyboard 164c and/or mouse or other cursor control or pointing device (e.g., trackpad, trackball).

The linebar resaw 106 typically includes a saw 166 including a saw blade 166a, a set of driven rollers 168a and a set of undriven rollers 168b. The sets of rollers, collectively 168, move the cant 130 laterally with respect to the saw blade 166a, adjusting a depth of cut or thickness of board 170 sawn or cut by the linebar resaw 106. This sawing or cutting produces two pieces, typically a board 170 and a smaller cant 130a. Resulting boards 170 may be advanced downstream by a first conveyor 171 as indicated by arrow 172. In some instances a second conveyor 173 may convey or transport the resulting boards 170 to the edger 108 for edging. In other instances, a third conveyor 174 may convey or transport the resulting boards 170 to the grading station 112 for grading as indicated by arrow 183. In still other instances, a fourth conveyor 175 may convey or transport the resulting pieces directly to the sorting deck 114 as indicated by arrow 190. For instance, at some point of processing, a size and/or grade of a piece may only be suitable for use in pallets or rail ties, and may be directly sent to the sorting deck 114.

In some implementations, one or more conveyors, such as chains 175, a second transfer table 176, a roll case 177, and the first transfer table 134b, may return resulting cants 130a to the flipping deck 104, as indicated by arrows 178, 179, 132, respectively. At the flipping deck 104, the human operator 156 again visually inspects one or more sides of the cant 130a to determine the longitudinal rotational orientation that will result in an optimized value of lumber being produced by the linebar resaw 106. As noted above, the control subsystem 164 may aid, or completely replace, the human operator 156.

A fifth conveyor 180 may transport lumber from the edger 108 to the grading station 112 with associated input device as indicated by arrow 181, while the third conveyor 174 may transport lumber from the linebar resaw 106 to the grading station 112. At the grading station 112, a human 182 typically grades the resulting lumber. The human 182 visually inspects the boards 170, assigning a grade, which may entered into a processor-based system via a user input device and/or physically marked on the boards 170 by the human 182. The grade may represent quality assessment of the boards 170, for instance a lack or a presence of surface imperfections or aberrations, or even an extensiveness and/or severity of such imperfections or aberrations.

The value of the boards 170 is typically a function of a grade of the boards 170 and an approximate volume of the boards 170. Thus, it is necessary to assess the volume of the boards 170. The volume is approximated. In lumber mills, logs are normally cut (or bucked) into log segments with very specific lengths (plus or minus a tolerance). The human 182 may determine the approximate length of the boards 170. The length of the board 170 is typically based on a nominal length of the board. The nominal length of a board is generally less than the actual length. To determine the nominal length, the actual length must be greater than the nominal length by some tolerance factor. Then the nominal length is the actual length rounded down to a nearest foot or other unit of length. For example, boards slightly longer than 7 feet are considered to be 7 feet long when determining nominal length. However boards that are not sufficiently longer than a particular foot or unit value, (i.e., by less than the tolerance value) are rounded down by an additional foot or unit value. For example, board that is greater than 7 feet by less than the tolerance value is considered to have a 6 foot long nominal length. The nominal length of a board, not the actual length, is the length that is typically used in calculating the surface area or volume of a board.

The human 182 may also assess the width of the boards 170, as well as thickness. The board width may be measured to a nearest foot or other unit of measurement. In industry parlance a board with its round up is denominated as a “skinny” board having less fiber or wood than reflected by the dollar value, while a board that has been rounded down is denominated as a “fat” board having more fiber or wood than reflected by the dollar value. Conventional approaches which determine longitudinal rotational orientation to produce the highest grade piece is believed to result in a fairly equal distribution between boards that have been rounded up and boards that have been rounded down. Approaches described herein are believed to result in a higher distribution of boards which have been rounded up relative to boards which have been rounded down.

From the grading station 112, a sixth conveyor 184 typically transports the boards 170 downstream to the trimmer 110, as indicated by arrow 185. The trimmer 110 typically includes one or more saws (e.g., round saws) 186a, 186b (collectively 186) oriented to trim one or both ends of the boards 170, adjusting the length of the boards 170. A seventh conveyor 187 then transports the boards 170 to the sorting deck 114, as indicated by arrow 191.

In some implementations a diverter and/or eighth conveyor 188 may transport some of the boards 170 from the grading station 112 back toward an input of the edger 108, as indicated by arrow 189. Such may, for instance, be used to remove wane to increase the grade, and hence value of the boards 170. Such may be responsive to an edger optimizer.

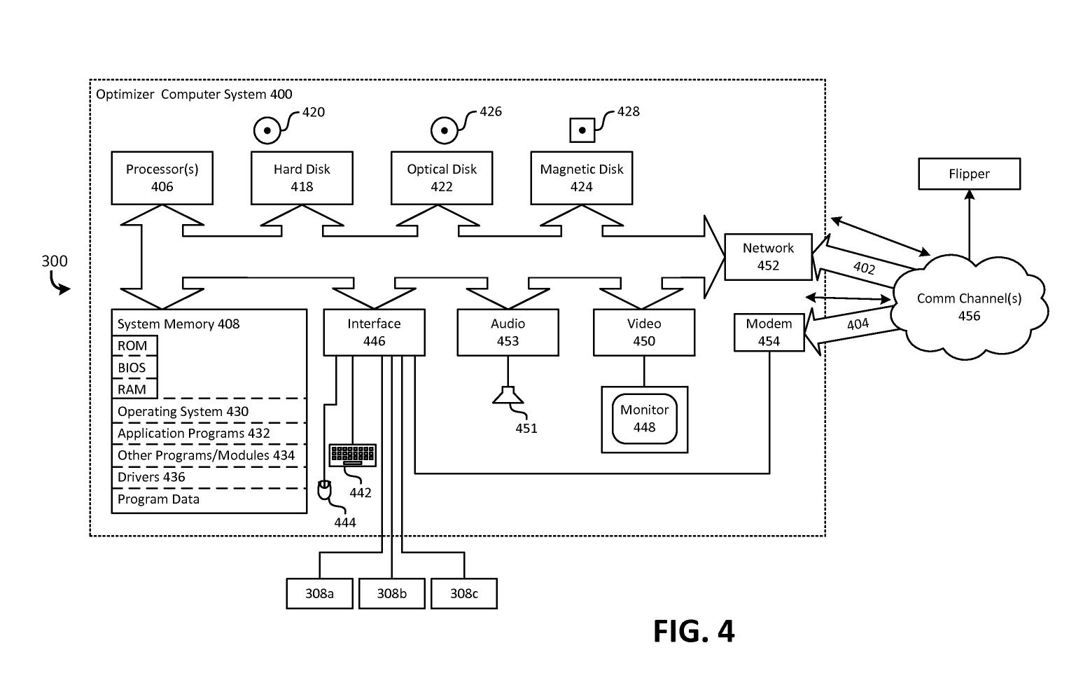

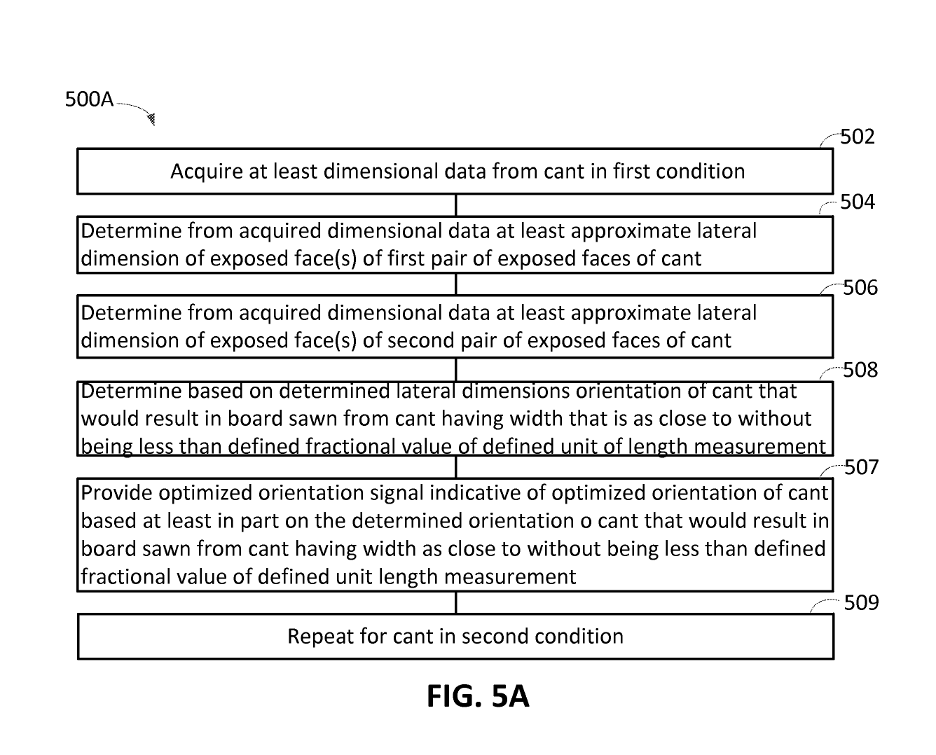

While generally omitted from this discussion, it is recognized that the lumber mill environment 100 may include one or more optimizer systems 300 (as shown in FIG. 4). As part of automating the lumber mill, one or more optimizer systems 300 (as shown in FIG. 4), commonly referred to as optimizers, may be installed. The optimizer(s) analyze information about the input (e.g., cants, boards) of a set of operations (e.g., sawing), and automatically determine a number of parameters intended to optimize the operations, for example, to produce an optimized output. The optimizers typically include one or more acquisition devices (e.g., laser scanners, imagers such as camera, range finders) to acquire information from logs, cants or boards, and one or more computers programmed to process and/or analyze the acquired information and produce an optimized solution that is intended to optimize an output of the operation(s). The lumber mill environment 100 may include one or more optimizers 300 (as shown in FIG. 4) in conjunction with one or more pieces of equipment (e.g., the linebar resaws 106, the edger 108, trimmer 110).

For each piece of equipment to be monitored or optimized, one or more respective scan zones may be set up. For example, the lumber mill 100 may include a plurality of scan zones, for instance, one positioned proximate the flipper table 104 (FIG. 1), an edger scan zone (not shown), and/or a trimmer scan zone (not shown). It is recognized that the lumber mill environment 100 may include more or fewer scan zones, and the scan zones may be in different locations and be differently configured.

Based at least in part on the scanned geometry of a piece of wood, the optimizer computer simulates thousands of different ways to cut the piece of wood into lumber, and picks a solution intended to maximize a grade or volume of lumber produced. Inputs to this process include board size requirements, wane rules, grade rules and lumber prices. The software must simulate the behavior of different machines.

The acquisition devices 308 may take a variety of forms capable of sensing, capturing or otherwise acquiring information or data about the logs, cants and/or boards. The acquisition devices 308 are often visual or optical acquisition devices that optically sense, capture or otherwise acquire information or data about one or more dimensions of the logs, cants and/or boards. The acquisition devices 308 may include one or more cameras or other optical sensors, for example, an analog or digital video camera or digital still camera. Where an analog video camera is used, the acquisition devices 308 may include a frame grabber (not shown) to grab frames of the analog video and produce digital images (e.g., digital image data) suitable for processing. The acquisition devices 308 may include one or more light sources, for example, flood illumination sources (e.g., incandescent or gas discharge lamps or lights) or coherent sources (e.g., lasers, one- or two-dimensional laser scanners). Many commercially available laser scanners may be suitable, for example, those sold by JoeScan Inc. Alternatively, other types of acquisition devices may be employed, for instance, contact sensors that physically contact the log, cant or board, to sense or acquire dimensions, or acoustic sensors that acoustically sense or acquire the dimensions.

The lumber mill environment 100 may advantageously include one or more optimizer systems 300 (as shown in FIG. 4), each of which includes at least one optimizer computer system 400 and one or more acquisition devices 308. The acquisition devices 308 may be set up to form one or more optimizer system scan zones. The optimizer system may simulate different ways to cut a piece of wood into lumber and select a solution intended to maximize the value of lumber produced.

FIGS. 2A-2E show a cant 200, according to one illustrated embodiment.

The cant 200 has two ends 202a, 202b (collectively 202) and a length 204 therebetween. The cant 200 may have a first pair of exposed faces or surfaces 206a, 206b and a second pair of exposed faces or surfaces 206c, 206d. The exposed faces or surfaces 206a, 206b of the first pair are generally opposed from one another across the center of the cant 200. The exposed faces or surfaces 206c, 206d of the second pair are generally opposed from one another across the center of the cant 200. The cant 200 may include one or more abnormalities (e.g., knot holes, sap) 208a, 208b, 208c (three shown, collectively 208) which may be visible at one or more of the faces (collectively 206).

The cant 200 may be in a first condition, for example, produced by the head rig 102 (FIG. 1), or may be in a second or some later condition, for example, after being sawn one or more times by the linebar resaw 106 (FIG. 1). After sawing by the linebar resaw 106 (FIG. 1), the general shape of the cant 200 remains substantially unchanged, however the dimensions of the cant 200 change since a board has been sawn from the cant 200.

A center of the cant 200 is typically denominated as the “pith” 210. The quality of grade of the wood typically decreases as traversed from an outer perimeter or exterior of the cant toward the pith. In many instances, once the cant has been sawn a few times, the size or grade of the remaining cant 200 is only suitable for less valuable uses, for instance, as pallet material or for rail ties.

FIG. 3 shows the cant 200 with hypothetical saw lines or cuts 212a, 212b, according to one illustrated embodiment.

If sawn or cut parallel to a first lateral dimension indicated by axis 214a, along a first saw line or cut 212a, the resulting board 216a would have a width indicated as A in FIG. 3. That would leave the remaining cant 200 with a dimension indicated as D in FIG. 3 along a second lateral dimension, indicated by axis 214b.

In contrast, if sawn or cut parallel to the second lateral dimension indicated by axis 214b, along a second saw line or cut 212b, the resulting board 216b would have a width indicated as B in FIG. 3. That would leave the remaining cant 200 with a dimension indicated as C in FIG. 3 along the first lateral dimension, indicated by axis 214a.

As is readily apparent from FIG. 3, a rotational orientation about a longitudinal axis (illustrated as arrowhead 218 coming out of the plane of the drawing sheet) may dictate the width of the resulting board 216a, 216b. Thus, a rotational longitudinal orientation of the cant may be selected to produce the widest board possible from a given cant 200 in a given condition or state.

FIG. 4 shows an optimizer system 300 that may be used in controlling at least some of the equipments illustrated in FIG. 1, according to one illustrated embodiment. The optimizer system 300 includes one or more acquisition devices 308 and a computer system 400.

The optimizer computer system 400 is optionally coupled by one or more communications channels/logical connections 402, 404 to a piece of lumber mill equipment, for example, a flipper 162 of flipper table 104. Optionally, one or more communications channels/logical connections 402, 404 may communicatively couple the optimizer computer system 400 to one or more communications networks (not shown). In other embodiments, the optimizer computer system 400 need not be coupled to a network. The communications channels/logical connections 402, 404 may allow the optimizer computer system 400 to send information useful in automating operation or performance of the lumber mill. For example, the optimizer computer system 400 may send signals that indicate an optimal rotational longitudinal orientation for cant. Such signals may be sent to a human operator and/or to a piece of lumber mill equipment (e.g., flipper 162, conveyer(s)). The communications channels/logical connections 402, 404 may allow the optimizer computer system 400 to receive information useful in automating operation or performance of the lumber mill. For example, the optimizer computer system 400 may receive updated lumber pricing information and/or rule changes such as new wane rules. Also for example, the optimizer computer system 400 may receive information from the one or more acquisition devices 308.

The optimizer computer system 400 may take the form of a conventional PC, which includes a processing unit 406, a system memory 408 and a system bus 410 that couples various system components including the system memory 408 to the processing unit 406. The optimizer computer system 400 will at times be referred to in the singular herein, but this is not intended to limit the embodiments to a single computing system, since in certain embodiments, there will be more than one computer system involved. Non-limiting examples of commercially available optimizer computers include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 406 may be any one or more logic processing units, such as one or more central processing units (CPUs), digital signal processors (DSPs), application-specific integrated circuits (ASICs), field programmable gate arrays (FPGAs), etc. Unless described otherwise, the construction and operation of the various blocks shown in FIG. 4 are of conventional design. As a result, such blocks need not be described in further detail herein, as they will be understood by those skilled in the relevant art.

The system bus 410 can employ any known bus structures or architectures, including a memory bus with memory controller, a peripheral bus, and a local bus. The system memory 408 includes read-only memory (“ROM”) 412 and random access memory (“RAM”) 414. A basic input/output system (“BIOS”) 416, which can form part of the ROM 412, contains basic routines that help transfer information between elements within the lumber mill control system 400, such as during start-up.

The optimizer computer system 400 also includes a hard disk drive 418 for reading from and writing to a hard disk 420, an optical disk drive 422 and a magnetic disk drive 424 for reading from and writing to removable optical disks 426 and magnetic disks 428, respectively. The optical disk 426 can be a CD or a DVD, while the magnetic disk 428 can be a magnetic floppy disk or diskette. The hard disk drive 418, optical disk drive 422 and magnetic disk drive 424 communicate with the processing unit 406 via the system bus 410. The hard disk drive 418, optical disk drive 422 and magnetic disk drive 424 may include interfaces or controllers (not shown) coupled between such drives and the system bus 410, as is known by those skilled in the relevant art. The drives 418, 422, 424, and their associated computer-readable media 420, 426, 428, provide nonvolatile storage of computer-readable instructions, data structures, program modules and other data for the optimizer computer system 400. Although the depicted optimizer computer system 400 employs hard disk 420, optical disk 426 and magnetic disk 428, those skilled in the relevant art will appreciate that other types of non-transitory computer- or processor readable media that can store data accessible by a computer may be employed, such as magnetic cassettes, flash memory cards, Bernoulli cartridges, RAMs, ROMs, smart cards, etc.

Program modules can be stored in the system memory 408, such as an operating system 430, one or more application programs 432, other programs or modules 434, drivers 436 and program data 438. While shown in FIG. 4 as being stored in the system memory 408, the operating system 430, application programs 432, other programs/modules 434, drivers 436 and program data 438 can be stored on the hard disk 420 of the hard disk drive 418, the optical disk 426 of the optical disk drive 422 and/or the magnetic disk 428 of the magnetic disk drive 424. A user can enter commands and information into the optimizer computer system 400 through input devices such as a touch screen or keyboard 442 and/or a pointing device such as a mouse 444. Other input devices can include a microphone, joystick, game pad, tablet, scanner, etc. These and other input devices are connected to the processing unit 406 through an interface 446 such as a universal serial bus (“USB”) interface that couples to the system bus 410, although other interfaces such as a parallel port, a game port or a wireless interface or a serial port may be used. A monitor 448 or other display device is coupled to the system bus 410 via a video interface 450, such as a video adapter. A speaker 451 is coupled to the system bus 410 via an audio interface 453. The monitor 448 and/or speaker 451 may be operated to respectively provide visual and aural alerts, for example, to indicate an optimal rotational longitudinal orientation of a cant or, for example, in response to detecting an error, aberration or out of performance condition of the optimizer computer system 400 or a piece of lumber mill equipment. Although not shown, the optimizer computer system 400 can include other output devices, such as printers, etc.

The optimizer computer system 400 may operate in a networked environment using one or both of the logical connections 402, 404 to communicate with one or more remote computers, servers and/or devices through the network 456. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a WAN networking environment, the optimizer computer system 400 may include a modem 454 for establishing communications over the WAN 404. Alternatively, another device, such as the network interface 452 (communicatively linked to the system bus 410), may be used for establishing communications over the WAN 402. The modem 454 is shown in FIG. 4 as communicatively linked between the interface 446 and the WAN 404. In a networked environment, program modules, application programs, or data, or portions thereof, can be stored in a server computing system (not shown). Those skilled in the relevant art will recognize that the network connections shown in FIG. 4 are only some examples of ways of establishing communications between computers, and other connections may be used, including wirelessly.

As illustrated in FIG. 4, the optimizer computer system 400 is further coupled to a number of acquisition devices (collectively 308) at a number of scan zones, for example, one or more linear laser scanners 308a (only one illustrated), one or more planar laser scanners 308b (only one illustrated), and/or one or more image capture devices 308c (only one illustrated). The acquisition devices 308 can take any of a large variety of forms, such as many forms that are commercially available. For example, various suitable forms of laser scanners 308a, 308b may be obtained from JoeScan Inc., including three-dimensional laser scanners. Such laser scanners typically include one or more laser sources, moving (e.g., pivoting, rotating or oscillating) reflectors or mirrors and one or more optical sensors. Also, for example, various forms of suitable image capture device 308c may be employed, including digital cameras (e.g., still, moving, video), CCD arrays, CMOS cameras, analog cameras with frame grabbers and the like. Additionally or alternatively, the acquisition devices 308 may employ non-optical devices, for instance, various forms of range finders, for instance, electroacoustic range finders.

The acquisition devices 308 may be communicatively coupled to the system bus 410 through the interface 446 and are thereby communicatively coupled to the optimizer computer system 400. The optimizer computer system 400 may further include various optimization application programs 432 for receiving data from the acquisition devices 208, processing that data, and determining optimal solutions (e.g., rotational longitudinal orientation for sawing or cutting a given cant 200). As previously noted, the optimizer computer system 400 may receive up-to-date market information for lumber and/or rules (e.g., wane rules) via the network 456.

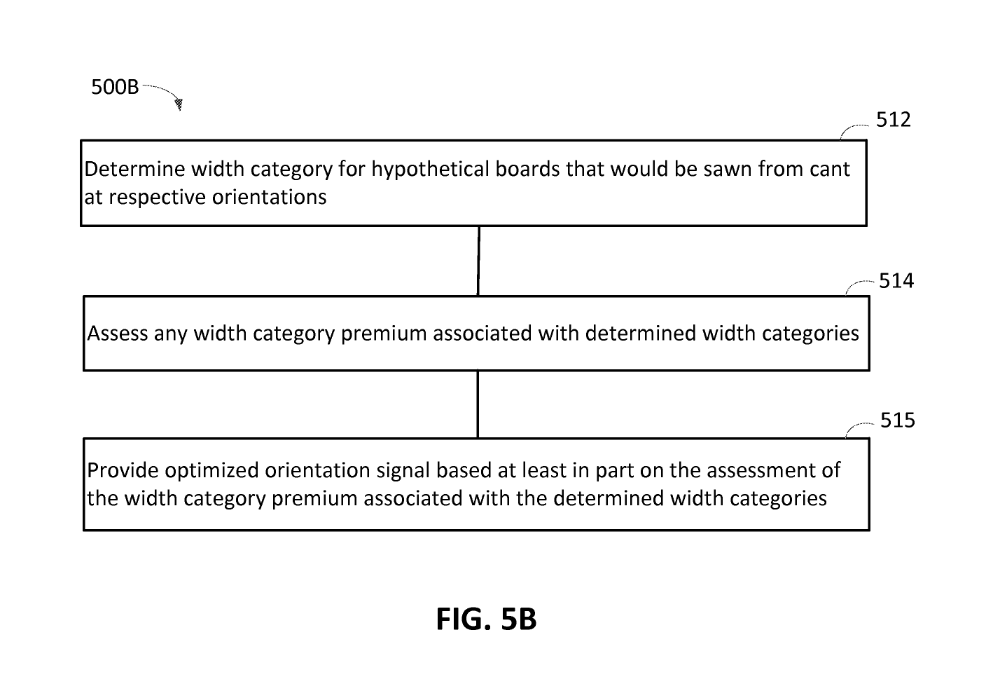

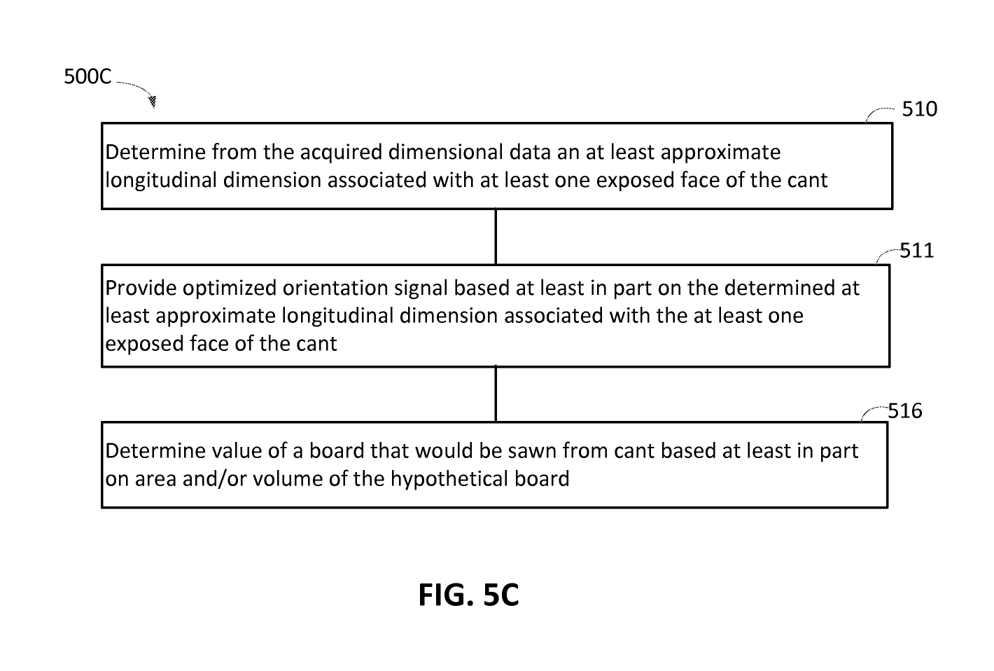

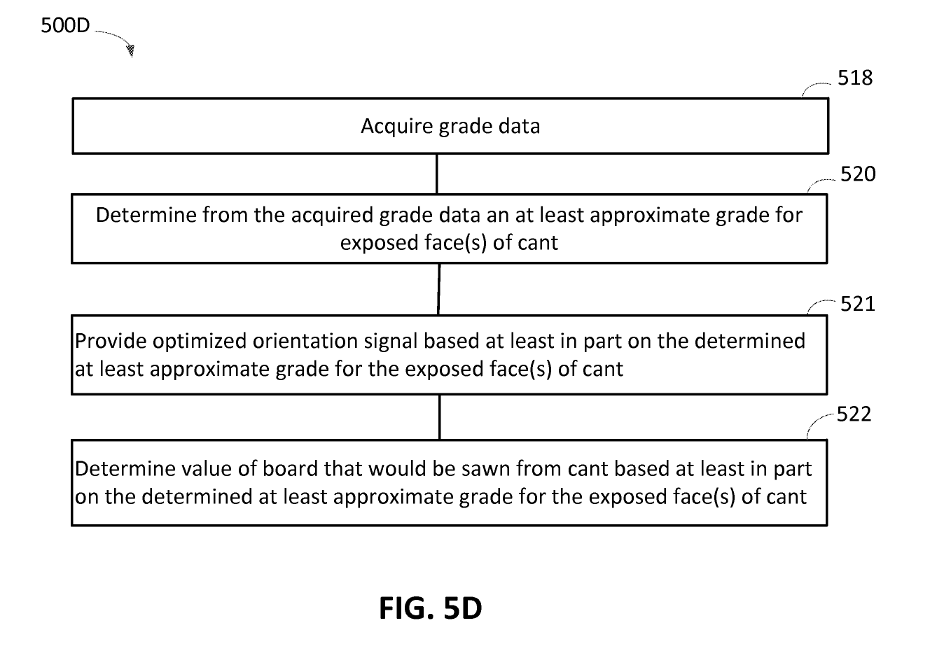

FIG. 5A shows a method 500A of operating an optimizer system 300, according to one illustrated embodiment.

At 502, one or more acquisition devices or units of an acquisition subsystem acquire at least dimensional data from a cant in a first condition. Such may include use of linear, two- or even three-dimensional laser scanners and/or cameras at one or more scan locations, for example, proximate the flipper table 104 (FIG. 1).

At 504, at least one processor determines an at least approximate lateral dimension of at least one exposed face of a first pair of exposed faces of the cant from the acquired dimensional data. The exposed faces of the first pair are generally opposed to one another across a center of the cant.

At 506, at least one processor determines an at least approximate lateral dimension of at least one exposed face of a second pair of exposed faces of the cant from the acquired dimensional data. Again, the exposed faces of the second pair are generally opposed to one another across the center of the cant, and are not parallel to the exposed faces of the first pair.

At 508, based on the determined at least approximate lateral dimensions, the at least one processor determines an orientation of the cant that would result in a board sawn from the cant having a width that is as close to without being less than a defined fractional value of a defined unit of measurement. For example, the processor(s) may determine a rotational longitudinal orientation of the cant that will result in sawing a board having a width that is as close to without being less than half of a foot.

At 507, the at least one processor provides an optimized orientation signal. The optimized orientation signal is indicative of an optimized rotational longitudinal orientation of the cant. Such may be based at least in part on the determined orientation of the cant that would result in a board sawn from the cant having the width that is as close to without being less than the defined fractional value of a defined unit of length measurement.

After the cant is sawn or cut, the method 500A may repeat at 509 for the now modified cant which is in second condition.

FIG. 5B shows a method 500B of operating an optimizer computer system 300, according to another illustrated embodiment. The method 500B may be combined with the method 500A.

At 512, the at least one processor determines a width category for each of a number of boards that would be sawn from the cant at a number of respective orientations. Notably, there are often premiums associated with various widths of boards. For example, less than four inches may be associated with a first width category which serves as a baseline, while boards greater than 4 inches but less than 6 inches may be associated with a second width category which includes a premium above the baseline. Further, boards greater than, for instance, 10 inches may be associated with a third width category, which is associated with an even higher premium. Various thresholds or cutoffs may be applied to define the different width categories, and any number of different width categories may be employed. The example given is not in any way intended to be limiting.

At 514, the at least one processor assesses any width category premium associated with the determined width categories. The optimized orientation signal may be generated based at least in part on an assessment of the width category premium, if any, associated with the determined width categories.

At 515, providing an optimized orientation signal by the at least one processor includes providing the optimized orientation signal based at least in part on the assessment of the width category premium associated with the determined width categories.

FIG. 5C shows a method 500C of operating an optimizer computer system 300, according to another illustrated embodiment. The method 500C may be combined with the method 500A and 500B.

At 510, the at least one processor determines an at least approximate longitudinal dimension associated with at least one exposed face of the cant from the acquired dimensional data.

At 511, providing an optimized orientation signal by the at least one processor includes providing the optimized orientation signal based at least in part on the determined at least approximate longitudinal dimension associated with the at least one exposed face of the cant.

At 516, the at least one processor determines a value of a board that would be sawn from the cant based at least in part on an area or a volume of a board that would be sawn from the cant. The area may be equal to a product of at least one of the determined lateral dimensions multiplied by the determined at least approximate longitudinal dimension of the cant. The volume may be equal to a product of at least one of the determined lateral dimensions multiplied by the determined at least approximate longitudinal dimension of the cant and a thickness equal to a defined sawing depth. Such may optionally take into account any premiums associated with a width category to which the hypothetical board would belong. Such may be performed using one or more lookup tables or other data structures, or in some implementations calculated via one or more mathematical equations executed by the at least one processor.

FIG. 5D shows a method 500D of operating an optimizer computer system 300, according to a further illustrated embodiment. The method 500C may be combined with the methods 500A, 500B, and 500C.

At 518, the at least one processor acquires grade data. Such will typically employ acquiring image data that includes a fairly detailed image of the face(s) of the cant. Such may additionally employ other types of data, for example, microwave or X-ray data that reveals subsurface aberrations or imperfections in the cant. Such may also include obtaining grading specifications, which may reflect grading standards and/or values associated with various grades. This information may change from time-to-time so up-to-date information would be valuable.

At 520, the at least one processor determines an at least approximate grade for at least one of the exposed faces of the cant from the acquired grade data. Such may include image processing to identify aberrations, abnormalities, imperfections or other undesirable traits in the cant such as knots, holes, splits, wane, etc. Such may be a completely automated process, or may rely on input from a human operator or inspector.

At 521, providing an optimized orientation signal by the at least one processor includes providing the optimized orientation signal based at least in part on the determined at least approximate grade for the at least one of the exposed faces of the cant.

At 522, the at least one processor determines a value of a board that would be sawn from the cant based at least in part on the determined at least approximate grade for the at least one of the exposed faces of the cant. Such may be in addition to, or as part of, assessing value based on volume and/or width premium.

After the cant in a first condition is sawn or cut, the methods 500A, 500B, 500C, 500D, or their combinations may repeat for the cant in a second combination.

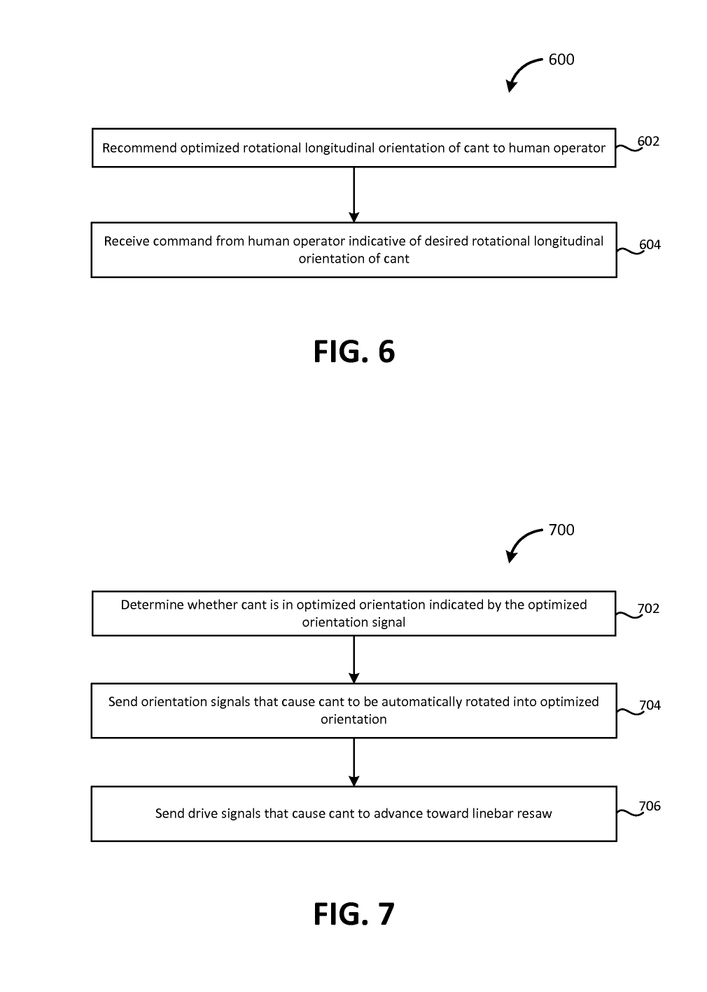

FIG. 6 shows a method 600 of operating an optimizer system 300, according to one illustrated embodiment. The method 600 may be used in performing the methods 500A, 500B, 500C, 500D, or their combinations (FIG. 5A-5D).

At 602, at least one processor causes a recommendation for an optimized rotational longitudinal orientation of a cant to be provided to a human operator. Such may include providing a visual prompt, such as a message on a display or changing a state (e.g., ON, OFF) of a light (e.g., LED). Such may additionally or alternatively include providing an aural prompt, such as a spoken message or other sound.

At 604, the at least one processor receives a command from the human operator via a user input device. The command may be indicative of a desired orientation of the cant. In response, the at least one processor may either cause the cant to be transported to the linebar resaw in its current orientation, or first cause the cant to be flipped before causing the cant to be transported to the linebar resaw.

FIG. 7 shows a method 700 of operating an optimizer system 300, according to one illustrated embodiment. The method 700 may be used in performing the methods 500A, 500B, 500C, 500D, or their combinations (FIG. 5A-5D).

At 702, at least one processor determines whether the cant is in the optimized orientation indicated by the optimized orientation signal.

At 704, the at least one processor sends orientation signals that cause the cant to be automatically rotated into the optimized orientation. Such may include sending signals to cause a flipper 162 (FIG. 1) of a flipper station or table 104 to cause the cant to rotate about the cant's longitudinal axis into a new orientation, for instance, in 90 degree increments.

At 706, once the cant is in the desired optimized orientation the at least one processor sends drive signals that cause the cant to advance toward a linebar resaw.

Thus, the at least one processor may automatically determine whether the cant is in the desired rotational longitudinal orientation, either causing the cant to be transported to the linebar resaw in its current orientation, or first causing the cant to be flipped before causing the cant to be transported to the linebar resaw.

Although not required, the embodiments have been described in the general context of computer-executable instructions, such as program application modules, objects, or macros being executed by a computer. Those skilled in the relevant art will appreciate that the illustrated embodiments as well as other embodiments can be practiced with other computer system configurations, including handheld devices, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information can be stored on any computer readable medium for use by or in connection with any computer and/or processor related system or method. In the context of this document, a memory is a computer readable medium that is an electronic, magnetic, optical, or other physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but is not limited to, an electronic, magnetic, optical, electromagnetic, infrared, or semiconductor system, apparatus, device, or propagation medium. More specific examples (a nonexhaustive list) of the nontransitory computer- or processor-readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), and a portable compact disc read-only memory (CDROM).

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. Pat. No. 7,853,349; U.S. Pat. No. 7,866,642; U.S. patent application Ser. No. 11/873,090 filed Oct. 16, 2007; U.S. patent application Ser. No. 12/424,402 filed Apr. 15, 2009 (published as US-2009-0255607); U.S. provisional patent application Ser. No. 61/450,011 filed Mar. 7, 2011; and U.S. patent application Ser. No. 13/366,028 filed Feb. 3, 2012 are incorporated herein by reference, in their entirety. Aspects of the embodiments can be modified, if necessary, to employ systems, circuits and concepts of the various patents, applications and publications to provide yet further embodiments.

Different arrangements of laser scanners may also be used to determine geometric characteristics of the boards. The laser scanners may also be positioned at still other locations downstream from the linebar resaw. Different imaging systems other than laser scanners may alternatively or additionally be used. The light source may comprise another collimated, non-laser light source or another, more diffuse source of electromagnetic radiation. The image sensor may also take variety of other forms.

The methods described herein may include additional acts, may omit some acts, and may perform or execute the acts in a different order than illustrated or described.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

1. A method of orienting a cant in lumber mills, comprising:
acquiring via a subsystem at least dimensional data from a cant in a first condition;
determining from the acquired dimensional data an at least approximate lateral dimension of a plurality of faces of the cant by at least one processor;
determining, based at least in part on the determined at least approximate lateral dimensions, an orientation of the cant that would result in a board sawn from the cant having a selected face from the plurality of faces; and
providing an orientation signal by the at least one processor, the orientation signal indicative of an orientation of the cant based at least in part on the determined orientation of the cant.

2. The method of claim 1, further comprising:
determining by the at least one processor a width category for each of a number of boards that would be sawn from the cant at a number of respective orientations, and
assessing any width category premium associated with the determined width categories, and wherein determining an orientation of the cant by the at least one processor is based at least in part on the assessment of the width category premium associated with the determined width categories.

3. The method of claim 1, further comprising:
determining from the acquired dimensional data an at least approximate longitudinal dimension associated with at least one exposed face of the cant by the at least one processor; and
wherein determining an orientation of the cant by the at least one processor is based at least in part on the determined at least approximate longitudinal dimension associated with the plurality of faces of the cant.

4. The method of claim 3, further comprising:
determining a value of a board that would be sawn from the cant based at least in part on an area or a volume of a board that would be sawn from the cant, the volume equal to a product of at least one of the determined lateral dimensions multiplied by the determined at least approximate longitudinal dimension of the cant and a thickness equal to a defined sawing depth.

5. The method of claim 1 wherein acquiring via a subsystem at least dimensional data from a cant in a first condition includes acquiring grade data which represents aberrations, if any, in a portion of the cant.

6. The method of claim 5, further comprising:
determining a value of a board that would be sawn from the cant based at least in part on the determined at least approximate grade for the at least one of the faces of the cant.

7. The method of claim 1, further comprising:
recommending the orientation of the cant to a human operator; and
receiving a command from the human operator, the command indicative of a desired orientation of the cant.

8. The method of claim 1, further comprising:
determining by the at least one processor whether the cant is in the orientation indicated by the orientation signal;
sending orientation signals by the at least one processor that cause the cant to be automatically rotated into the orientation.

9. The method of claim 1 wherein determining an orientation of the cant comprises determining based on the determined at least approximate lateral dimensions the orientation of the cant that will result in sawing a board having a width that is as close to without being less than half of a foot.

10. A system of orienting a cant in a lumber mill, comprising:
a data acquisition subsystem having at least one data collection component positioned to acquire at least dimensional data from a cant in a first condition;
at least one non-transitory processor-readable medium that stores at least one of instructions and data;
at least one processor, communicatively coupled to the data acquisition subsystem and the at least one non-transitory processor-readable medium, that, upon execution of the instructions:
determines from the acquired dimensional data an at least approximate lateral dimension of a plurality of exposed faces of the cant;
determines from the acquired dimensional data an at least approximate lateral dimension of at least one exposed face of a plurality of faces of the cant;
determines, based at least in part on the determined at least approximate lateral dimensions, an orientation of the cant that would result in a board sawn from the cant from a selected exposed face; and
provides an orientation signal indicative of an orientation of the cant based at least in part on the determined orientation of the cant.

11. The system of claim 10 wherein the at least one processor further:
determines a width category for each of a number of boards that would be sawn from the cant at a number of respective orientations, and
assesses any width category premium associated with the determined width categories, and determines the orientation of the cant based at least in part on the assessed width category premium associated with the determined width categories.

12. The system of claim 10 wherein the at least one processor further:
determines from the acquired dimensional data an at least approximate longitudinal dimension associated with at least one exposed face of the cant by the at least one processor; and
determines the orientation of the cant based at least in part on the determined at least approximate longitudinal dimension associated with the at least one exposed face of the cant.

13. The system of claim 12 wherein the at least one processor further:
determines a value of a board that would be sawn from the cant based at least in part on an area or a volume of a board that would be sawn from the cant, the volume equal to a product of at least one of the determined lateral dimensions multiplied by the determined at least approximate longitudinal dimension of the cant and a thickness equal to a defined sawing depth.

14. The system of claim 10 wherein the data acquisition subsystem further acquires grade data which represents aberrations, if any, in a portion of the cant, and the at least one processor determines from the acquired grade data an at least approximate grade for at least one of the faces of the cant by the at least one processor.

15. The system of claim 10 wherein the at least one processor further:
recommends the orientation of the cant to a human operator.

16. The system of claim 10 wherein the at least one processor further:
sends orientation signals to a portion of a flipper table that cause the cant to be automatically rotated into the orientation.

17. The system of claim 10 wherein the data acquisition subsystem includes at least one laser scanner acquisition device and at least one image acquisition device.

18. At least one non-transitory computer-readable medium that stores instructions that upon execution of the instructions:
determines from the acquired dimensional data an at least approximate lateral dimension of a plurality of exposed faces of a cant;
determines from the acquired dimensional data an at least approximate lateral dimension of at least one exposed face of a plurality of faces of the cant; and
determines, based at least in part on the determined at least approximate lateral dimensions, an orientation of the cant that would result in a board sawn from the cant from a selected face.

19. The at least one non-transitory computer-readable medium of claim 18 further storing instruction that upon execution of the instructions:
determines a width category for each of a number of boards that would be sawn from the cant at a number of respective orientations, and
assesses any width category premium associated with the determined width categories, and determines the orientation of the cant based at least in part on the assessed width category premium associated with the determined width categories.

20. The at least one non-transitory computer-readable medium of claim 18 further storing instruction that upon execution of the instructions:
determines from the acquired dimensional data an at least approximate longitudinal dimension associated with at least one face of the cant by the at least one processor; and
determines the orientation of the cant based at least in part on the determined at least approximate longitudinal dimension associated with the at least one face of the cant.
